(19) United States
(12) Patent Application Publication
(10) Pub. No.: US 2022/0396169 A1
(43) Pub. Date: Dec. 15, 2022

(54) SYSTEMS AND METHODS FOR INTEGRATING A STEP-DOWN TRANSFORMER INTO AN ELECTRIC VEHICLE CHARGING STATION

(71) Applicant: Volta Charging, LLC, San Francisco, CA (US)

(72) Inventor: Alexander Naasz, San Francisco, CA (US)

(21) Appl. No.: 17/839,238

(22) Filed: Jun. 13, 2022

Related U.S. Application Data
(60) Provisional application No. 63/210,363, filed on Jun. 14, 2021.

(51) Int. Cl. B60L 53/66; B60L 53/30

(52) U.S. Cl. CPC B60L 53/66; B60L 53/305

(57) ABSTRACT

Systems and methods are provided herein for integrating a step-down transformer into an electric vehicle charging station (EVCS). Integrating a step-down transformer into an EVCS optimizes electric vehicle charging and provides for more flexible EVCS placement. For example, the EVCS's power source (e.g., electrical room) can transmit power to the EVCS at a higher voltage (e.g., 480 V) because the power will be stepped down by the EVCS before charging an electric vehicle at a lower voltage (e.g., 240 V). Transmitting power at a higher voltage reduces power loss during transmission so electric vehicles can be charged more efficiently.

### BACKGROUND

The present disclosure relates to electric vehicle charging stations (EVCSs), and in particular to techniques for increasing the efficiency of EVCSs.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS and the EVCS supplies electrical current to the user's electric vehicle. The cables and control systems of the EVCSs can be housed in kiosks in locations to allow a driver of an electric vehicle to park the electric vehicle close to an EVCS and begin the charging process. These kiosks may be placed in areas of convenience, such as in parking lots at shopping centers, in front of commercial buildings, or in other public places.

EVCSs are often characterized by how quickly they will recharge an electric vehicle's battery. For example, level one (L1) charging stations often take over a day to charge an empty electric vehicle battery. The charge time is due, in part, to the L1 charging stations using a 120-volt (V) voltage supply (e.g., a standard 120 V alternating current (AC) outlet) and supplying an output to an electric vehicle's battery of around 1.3 kilowatts (kW) to 2.4 kW per hour. Level two (L2) charging stations can often fully charge an electric vehicle's battery in eight hours or less. The L2 charging stations use a voltage supply over 200 V (e.g., 208 V to 240 V) and supply an output to an electric vehicle's battery of around 3 kW to 19 kW per hour. Level three (L3) charging stations or Direct Current Fast Chargers (DCFCs) can often completely charge an electric vehicle's battery in under ninety minutes. The L3 charging stations often use a voltage supply of 480 V and supply direct current straight to the electric vehicle's battery at around 50 kW to 350 kW per hour.

EVCSs of all levels need to be in locations (e.g., parking lots at shopping centers, in front of commercial buildings, etc.) where they can be readily accessible to users. That is, the charging cables of the EVCSs need to be able to reach electric vehicle parking spots. L1 and L2 EVCSs are often small and lack space to house any type of step-down or step-up transformers, so they must receive the correct level of voltage using cables running from a central power source (e.g., central electrical room). Traditionally, a central electrical room uses one or more step-down transformers to step down the power received from powerlines until the power is at an appropriate voltage level for the L1 and L2 EVCSs. The central electrical room then transmits the power, now at the appropriate voltage level, over cables to the respective L1 and L2 EVCSs, where the EVCSs use the power to charge the electric vehicles.

The current techniques for providing the correct voltage level to EVCSs result in a number of inefficiencies. For example, transmitting the stepped-down power from the electrical room to the EVCSs often results in power loss due to the low voltage (e.g., 120 V, 208 V, 240 V, etc.) and higher current of the stepped-down power. Current techniques result in less flexible EVCS placement because EVCSs need to be relatively close to the electrical room due, in part, to the power loss associated with transmitting the stepped-down power. This is particularly problematic for media-enabled EVCSs that are designed to be placed in areas where they can be easily seen by potential consumers. In many cases, media-enabled EVCSs are viewed by the maximum number of consumers when they are distributed over a larger area in places where they can be seen. The current techniques often result in media-enabled EVCSs being grouped in a small area near the electrical room because power loss increases as the EVCSs are farther away from the electrical room. This results in suboptimal consumer interactions. Further, being limited to a smaller charging voltage supply range (e.g., 208 V-240 V) limits EVCSs' versatility and compatibility with future upgrades. For example, some users prefer the charging speeds of L3 EVCSs. If an L2 EVCS has the ability to charge using L3 charging speeds and/or L2 charging speeds depending on the user preferences and/or electric vehicle requirements, said L2 EVCS will be able to service many more users. Current techniques lack an EVCS with the ability to charge electric vehicles using a wider range of voltage supply.

Various systems and methods described herein address these problems by integrating a step-down transformer into an EVCS. In some embodiments, an EVCS comprises a display that can be used to provide media to a user to enhance the user's charging experience. Consequently, passers-by, in addition to users of the EVCS, may notice media content displayed by the EVCS. The larger display results in a larger EVCS kiosk and provides room for the EVCS to house a step-down transformer. When an electrical room provides power to the EVCS, the electrical room is not required to step down the power to a low voltage (e.g., 208 V), because the EVCS can step down the power using its own step-down transformer. This allows the electrical room to transmit power to the EVCS at a higher voltage (e.g., 480 V), resulting in less power loss due to the higher voltage and lower current. Further, the EVCSs can be located farther away from the electrical room resulting in more flexible placement and more user interactions. The EVCS receives the power at a higher voltage (e.g., 480 V) from the electrical room and can either supply the power to an electric vehicle or can step down the voltage to a lower voltage (e.g., 208 V) if required by an electric vehicle. As an added benefit, stepping down the power at the EVCS can result in a more efficient charge because the stepped down power is transmitted directly to the electric vehicle after being stepped down instead of first being transmitted over cables from the electrical room.

The EVCS comprising a step-down transformer can also result in less hardware and fewer labor costs. For example, the current step-down transformers (e.g., 30 kVa, 125 kVa, etc.) that are installed in electrical rooms are often more expensive (e.g., $6,000-$14,000) and larger as they have to service multiple charging stations, while the step-down transformers (e.g., 15 kVa) included in the EVCSs are relatively inexpensive ($1,500). This results in significant cost savings that are multiplied for each installation. In another example, the installation costs are greatly reduced because installers of the EVCS are no longer required to install a step-down transformer in the electrical room. Traditionally, installing the larger, more expensive step-down transformers in the electrical room is a labor-intensive process and can have a number of added challenges. For example, not only does the size of the larger step-down transformers often make moving and transporting the larger step-down transformers difficult, but it can also make installation in smaller electrical rooms problematic. For the larger step-down transformers to work properly and safely there are rules, regulations, and procedures that often require components of the larger step-down transformers to be separated from other components in an electrical room by a certain distance. Electrical rooms can vary in size and are often small, making the installation of the larger step-down transformers difficult in view of these requirements. Installing an EVCS comprising a step-down transformer requires lower labor costs because no step-down transformer needs to be installed in the electrical room as a step-down transformer is housed within the EVCS. An EVCS that comprises a step-down transformer can result in a reduction of future labor costs as well. As mentioned above, having the EVCS comprise a step-down transformer allows for the EVCS to provide a wider array of charging types. The wider array of charging types means that existing infrastructures (e.g., EVCSs, cables, wires, etc.) will not have to be removed and replaced due to future product changes (e.g., more electric vehicles preferring/requiring L3 charging speeds).

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for integrating a step-down transformer into an EVCS, in accordance with some embodiments of the disclosure;

FIGS. 2A-2E illustrate an example of an EVCS comprising a step-down transformer, in accordance with some embodiments of the disclosure;

FIGS. 3A and 3B illustrate another example of an EVCS comprising a step-down transformer, in accordance with some embodiments of the disclosure;

FIG. 4 shows an illustrative block diagram of an EVCS system, in accordance with some embodiments of the disclosure;

FIG. 5 shows an illustrative block diagram of a user equipment device system, in accordance with some embodiments of the disclosure;

FIG. 6 shows an illustrative block diagram of a server system, in accordance with some embodiments of the disclosure;

FIG. 7 is an illustrative flowchart of a process for charging an electric vehicle using an EVCS comprising a step-down transformer, in accordance with some embodiments of the disclosure;

FIG. 8 is another illustrative flowchart of a process for charging an electric vehicle using an EVCS comprising a step-down transformer, in accordance with some embodiments of the disclosure;

FIG. 9 is an illustrative flowchart of a process for installing a step-down transformer into an EVCS, in accordance with some embodiments of the disclosure;

FIGS. 10A-10D illustrate an example of a process for installing a step-down transformer into an EVCS, in accordance with some embodiments of the disclosure; and

FIG. 11 illustrates another example of an EVCS comprising a step-down transformer, in accordance with some embodiments of the disclosure; and

FIG. 12 illustrates an EVCS comprising a step-down transformer charging an electric vehicle, in accordance with some embodiments of the disclosure.

### DETAILED DESCRIPTION

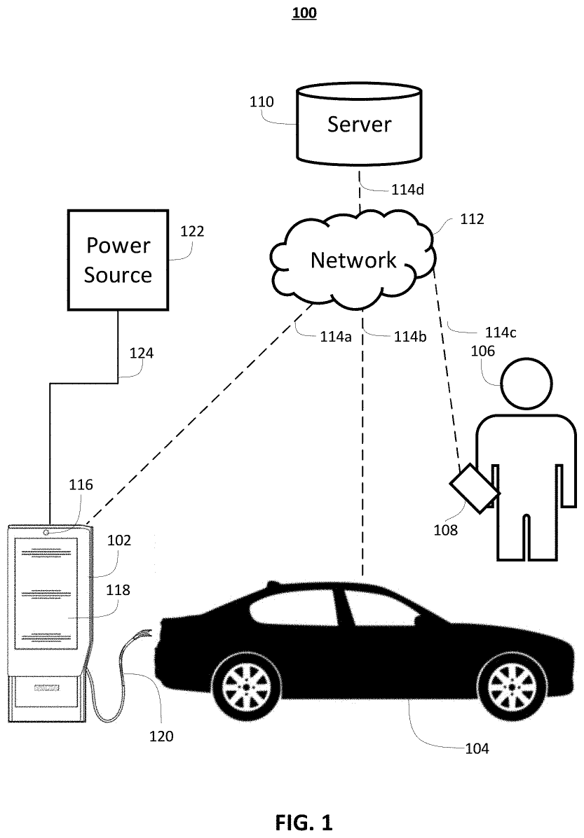

FIG. 1 shows an illustrative diagram of a system 100 for integrating a step-down transformer into an EVCS 102, in accordance with some embodiments of the disclosure. In some embodiments, the EVCS 102 provides an electric charge to the electric vehicle 104 via a wired connection, such as a charging cable 120, or a wireless connection (e.g., wireless charging). The EVCS 102 may be in communication with the electric vehicle 104 or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user, 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, servers, and/or electric vehicles, so that the items may communicate directly with each other via communication paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other types of communications network or combinations of communications networks. In some embodiments, a communication network path comprises one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communication network path can be a wireless path. Communications with the devices may be provided by one or more communication paths but is shown as a single path in FIG. 1 to avoid overcomplicating the drawing.

In the system 100, EVCS 102 comprises a step-down transformer housed within the EVCS 102. In some embodiments, EVCS 102 receives power from a power source 122 (e.g., central electrical room) via cables 124. In some embodiments, the power source 122 transmits power to the EVCS 102 at a higher voltage (e.g., 480 V) because the EVCS 102 can step down the power using the step-down transformer. In some embodiments, when the power source 122 transmits power at a higher voltage to the EVCS 102 via cables 124 there is less power loss compared to transmitting power at a lower voltage due to the higher voltage and lower current of the transmitted power. In some embodiments, transmitting power at the high voltage allows for longer cables 124 between the power source 122 and EVCS 102 due to the reduction in power loss. In some embodiments, the EVCS 102 can be located a distance (e.g., 100 meters, 550 meters, etc.) from the power source 122 due to the longer cables 124, resulting in flexible placement and more user interactions (e.g., users viewing the display 118).

In some embodiments, the EVCS 102 receives the power at the higher voltage from the power source 122 and can either supply the power to the electric vehicle 104 or can step down the voltage to a lower voltage (e.g., 208 V) before supplying the power to the electric vehicle 104. In some embodiments, the EVCS 102 steps down the received power to a level based on characteristics (e.g., model, make, specifications, condition, etc.) of the electric vehicle 104 being charged. For example, the EVCS 102 may determine an optimal level (e.g., voltage level) for charging the electric vehicle 104 based on the make of the electric vehicle 104. In some embodiments, the EVCS 102 may determine a voltage level for charging the electric vehicle 104 based on the price paid by the user 106. For example, the user 106 may select to charge their electric vehicle 104 using a first charging rate that uses a first voltage level, where the first charging rate is cheaper than a second charging rate. In some embodiments, the first voltage level corresponding to the first charging rate may be lower than a second voltage level corresponding to a second, more expensive charging rate. In some embodiments, the EVCS 102 must step down the power received from the power source 122 before charging the electric vehicle 104 using the first charging rate. In some embodiments, the EVCS 102 does not need to step down the power received from the power source 122 before charging the electric vehicle 104 when using the second charging rate.

In some embodiments, the EVCS 102 steps down the power received from the power source 122 and charges the electric vehicle 104 using the stepped-down power based on determining a charging rate for the electric vehicle. In some embodiments, the charging rate is based on characteristics of the electric vehicle 104 being charged. To determine the charging rate based on characteristics of the electric vehicle 104, the EVCS 102 must first be able to accurately identify characteristics corresponding to the electric vehicle 104. In some embodiments, the EVCS 102 uses one or more sensors to capture information about the electric vehicle 104. For example, these sensors may be image (e.g., optical) sensors (e.g., one or more cameras 116), ultrasound sensors, depth sensors, IR cameras, RGB cameras, PIR cameras, heat IR, proximity sensors, radar, tension sensors, NFC sensors, and/or any combination thereof

In some embodiments, after the one or more sensors capture information, the EVCS 102 can use this information to determine the electric vehicle's 104 characteristics (e.g., model, make, specifications, condition, etc.). In some embodiments, using the data collected from the one or more sensors, the EVCS 102 can identify electric vehicle characteristics by leveraging machine learning. The EVCS 102 can use the determined electric vehicle characteristics to determine the charging rate. For example, using the camera 116, the EVCS 102 can determine the make and model of the electric vehicle 104. The EVCS 102 can then access a database to determine the optimal charging rate corresponding to the determined make and model and charge the electric vehicle 104 using the determined charging rate. In some embodiments, the database may be stored in the EVCS 102, the server 110, or a combination thereof In some embodiments, the EVCS 102 receives images of the license plate of the electric vehicle 104 from the camera 116. In some embodiments, the EVCS 102 reads the license plate (e.g., using optical character recognition) and uses the license plate information to determine vehicle characteristics of the electric vehicle 104. In some embodiments, the EVCS 102 uses a database to lookup vehicle characteristics of the electric vehicle 104 using the license plate information.

In some embodiments, the EVCS 102 uses user information to determine vehicle characteristics of the electric vehicle 104. For example, the user 106 may input vehicle characteristics into a profile that is accessible by the EVCS 102. In some embodiments, when the EVCS 102 determines that the user 106 is charging their electric vehicle 104, the EVCS 102 receives vehicle characteristics associated with the electric vehicle 104 from a profile associated with the user 106.

In some embodiments, the EVCS 102 can determine an estimated charge time to determine the charging rate for the electric vehicle 104. In some embodiments, the EVCS 102 can use the information captured by the one or more sensors to determine an estimated charge time. For example, the one or more sensors may determine that the electric vehicle's battery is 20% charged. Based on this information, the EVCS 102 can determine an estimated charge time (e.g., one hour). The EVCS 102 may determine the estimated charge time based on accessing a database where battery percentages correspond to estimated charge times. In some embodiments, the estimated charge time can be used in conjunction with and/or derived from information captured by the one or more other sensors. For example, using the camera 116, the EVCS 102 can determine the make and model of the electric vehicle 104, and a battery sensor can determine the battery percentage of the electric vehicle 104. The EVCS 102 can then access a database to determine the estimated charge time when using an optimal charging rate given the make, model, and battery percentage of the electric vehicle 104.

In some embodiments, EVCS 102 determines the charging rate for the electric vehicle 104 based on the information captured by the one or more sensors, user information (e.g., user's calendar, user feedback, user patterns, user profile, etc.), and/or location information (e.g., electrical grid information, site information, etc.). In some embodiments, site information relates to the parameters of the EVCS's location. For example, newer locations (malls, shopping centers, etc.) may have more advanced electrical architecture allowing for higher output (e.g., higher charging rates) of electrical energy compared to locations with older electrical architecture. In some embodiments, user information and/or location information may be derived independently from the information captured using the one or more sensors, in conjunction with the information captured using the one or more sensors, or some combination thereof.

In some embodiments, the step-down transformer is located near the EVCS 102 instead of housed inside the EVCS 102. In some embodiments, the step-down transformer may be located near one more EVCSs and steps down power for the one or more EVCSs. In some embodiments, an EVCS 102 houses a step-down transformer within the kiosk and supplies stepped-down power to a second EVCS that may or may not have its own step-down transformer.

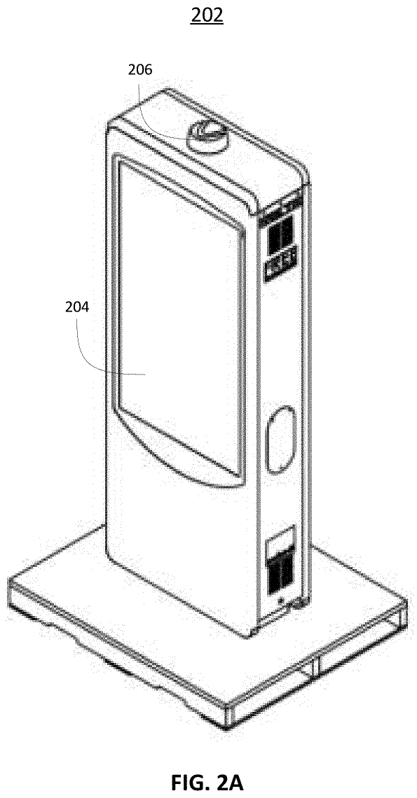

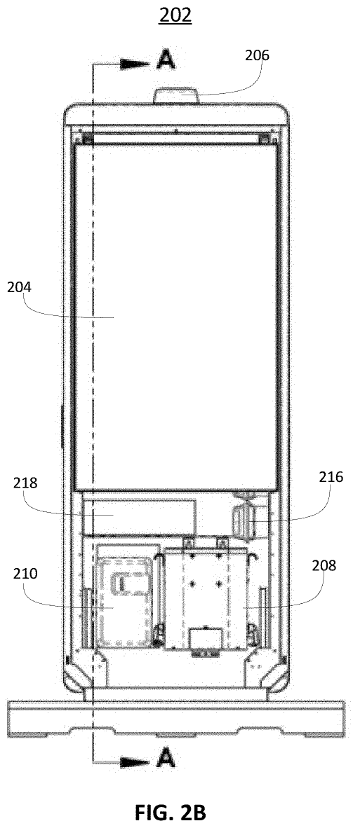

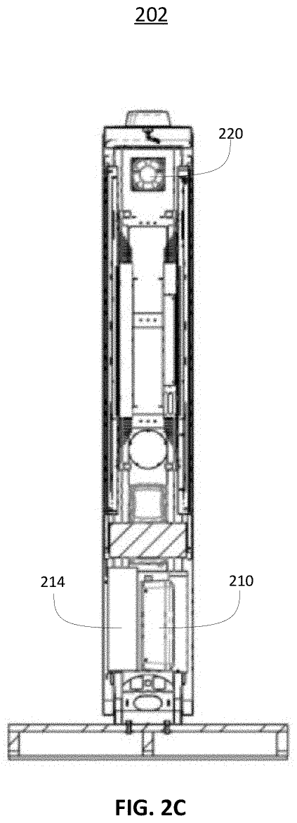

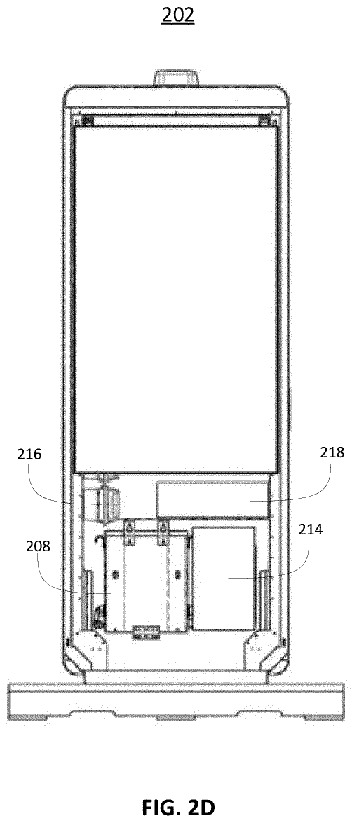

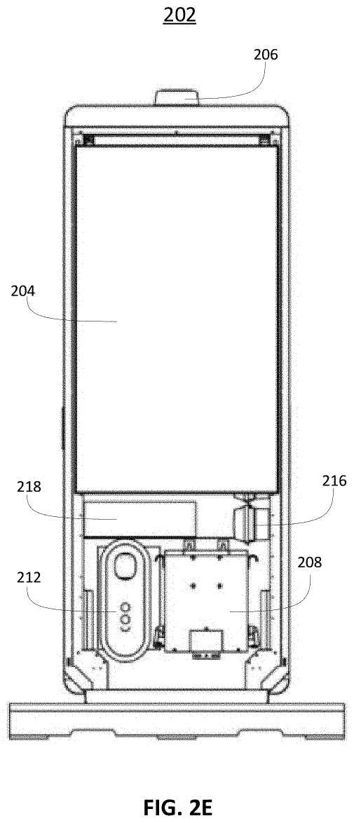

FIGS. 2A-2E illustrate an example of an EVCS comprising a step-down transformer, in accordance with some embodiments of the disclosure. In some embodiments, the EVCS 202 is the same as or similar to the EVCS 102 in FIG. 1 and comprises the same or similar components discussed above.

In some embodiments, EVCS 202 comprises a display 204 and camera 206 as described above. In some embodiments, EVCS 202 further comprises a step-down transformer 208 (e.g., 15 kV transformer) housed within the EVCS 202. In some embodiments, EVCS 202 receives power from a power source (e.g., central electrical room) at a higher voltage (e.g., 480 V) and the EVCS 202 can step down the power using the step-down transformer 208.

In some embodiments, EVCS 202 further comprises a charger (e.g., 210 and/or 212) coupled to the step-down transformer 208. A first charger type 210 (FIG. 2B) and second charger type 212 (FIG. 2E) are shown displaying the modularity of the EVCS 202. In some embodiments, EVCS 202 further comprises a circuit breaker panel 214 (e.g., 125A circuit breaker panel) and one or more receptacle boxes 216 (e.g., NEMA 5-15 120VAC receptacle boxes).

In some embodiments, EVCS 202 further comprises a motor within a fan-cooled environmental enclosure 218. In some embodiments, EVCS 202 further comprises one or more intake fans (not shown) and one or more exhaust fans 220. In some embodiments, the one or more intake fans and/or exhaust fans 220 are high-flow fans.

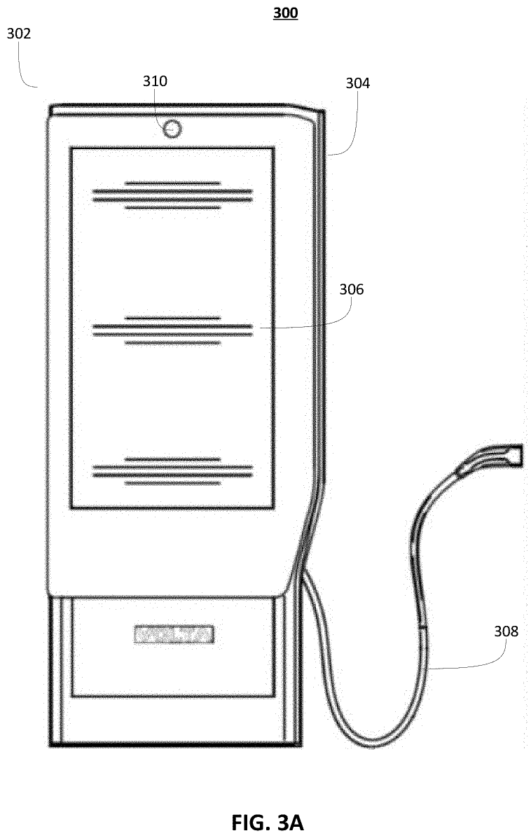

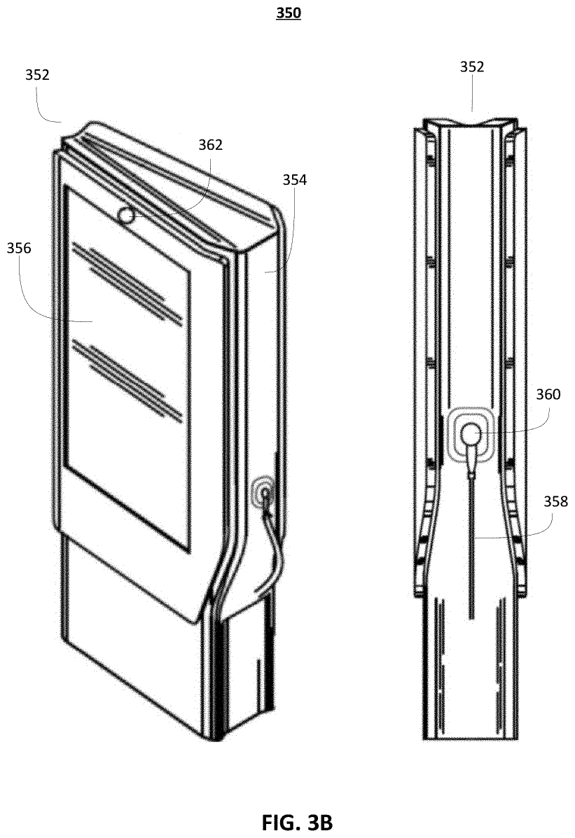

FIGS. 3A and 3B illustrate more examples of an EVCS comprising a step-down transformer. In some embodiments, FIGS. 3A and 3B illustrate the EVCSs displayed in FIGS. 1, and 2A-2E. EVCS 302 includes a housing 304 (e.g., a body or a chassis) that holds a display 306 and a step-down transformer (not shown). In some embodiments, EVCS 302 receives power from a power source (e.g., central electrical room) at a higher voltage (e.g., 480 V) and the

EVCS 302 can step down the power using the step-down transformer. In some embodiments, EVCS 302 comprises more than one display. For example, EVCS 302 may have a first display 306 and a second display on the other side of EVCS 302. In some embodiments, the display 306 is large compared to the housing 304 (e.g., 60% or more of the height of the frame and 80% or more of the width of the frame), allowing the display 306 to function as a billboard, capable of conveying information to passersby. In some embodiments, the one or more displays 306 display messages (e.g., media items) to users of the EVCS 302 (e.g., operators of the electric vehicle) and/or to passersby that are in proximity to the EVCS 302. In some embodiments, the display 306 has a height that is at least three feet and a width that is at least two feet.

EVCS 302 further comprises a computer that includes one or more processors and memory. In some embodiments, the memory stores instructions for displaying content on the display 306. In some embodiments, the computer is disposed inside the housing 304. In some embodiments, the computer is mounted on a panel that connects (e.g., mounts) a first display (e.g., a display 306) to the housing 304. In some embodiments, the computer includes a near-field communication (NFC) system that is configured to interact with a user's device (e.g., user device 108 of a user 106 in FIG. 1).

EVCS 302 further comprises a charging cable 308 (e.g., connector) configured to connect and provide a charge to an electric vehicle (e.g., electric vehicle 104 of FIG. 1). In some embodiments, the charging cable 308 is an IEC 62196 type-2 connector. In some embodiments, the charging cable 308 is a “gun-type” connector (e.g., a charge gun) that, when not in use, sits in a holder (e.g., a holster). In some embodiments, the housing 304 houses circuitry for charging an electric vehicle. For example, in some embodiments, the housing 304 includes power supply circuitry as well as circuitry for determining a state of a vehicle being charged (e.g., whether the vehicle is connected via the connector, whether the vehicle is charging, whether the vehicle is done charging, etc.). In some embodiments, EVCS 302 supports ISO 15118, which allows a user to plug their electric vehicle into EVCS 302 and begin charging without inputting any additional information. ISO 15118 is a communication interface, which, among other things, can identify the make and model of an electric vehicle to an EVCS. When an electric vehicle that supports ISO 15118 begins charging, EVCS 302 can receive vehicle characteristics (e.g., make and model of the electric vehicle) using ISO 15118.

EVCS 302 further comprises one or more cameras 310 configured to capture one or more images of an area proximal to EVCS 302. In some embodiments, the one or more cameras 310 are configured to obtain video of an area proximal to the EVCS 302. For example, a camera may be configured to obtain a video or capture images of an area corresponding to a parking spot associated with EVCS 302. In another example, another camera may be configured to obtain a video or capture images of an area corresponding to a parking spot next to the parking spot of EVCS 302. In some embodiments, the camera 310 may be a wide-angle camera or a 360° camera that is configured to obtain a video or capture images of a large area proximal to EVCS 302. The one or more cameras 310 may be mounted directly on the housing 304 of EVCS 302 and may have a physical (e.g., electrical, wired) connection to EVCS 302 or a computer system associated with EVCS 302. In some embodiments, the one or more cameras 310 (or other sensors) may be disposed separately from but proximal to the housing 304 of EVCS 302. In some embodiments, the camera 310 may be positioned at different locations on EVCS 302 than what is shown. In some embodiments, the one or more cameras 310 include a plurality of cameras positioned at different locations on EVCS 302.

In some embodiments, EVCS 302 further comprises one or more sensors (not shown). In some embodiments, the one or more sensors detect external objects within a region (area) proximal to EVCS 302. In some embodiments, the area proximal to EVCS 302 includes one or more parking spaces, where an electric vehicle parks in order to use EVCS 302. In some embodiments, the area proximal to EVCS 302 includes walking paths (e.g., sidewalks) next to EVCS 302. In some embodiments, the one or more sensors are configured to determine a state of the area proximal to EVCS 302 (e.g., wherein determining the state includes detecting external objects or the lack thereof). In some embodiments, the external objects can be living or nonliving, such as people, kids, animals, vehicles, shopping carts, toys, etc. In some embodiments, the one or more sensors can detect stationary or moving external objects. In some embodiments, the one or more sensors may be one or more image (e.g., optical) sensors (e.g., one or more cameras 310), ultrasound sensors, depth sensors, Infrared (IR) cameras, Red Green Blue (RGB) cameras, Passive IP (PIR) cameras, heat IR, proximity sensors, radar, tension sensors, near field communication (NFC) sensors, and/or any combination thereof. The one or more sensors may be connected to EVCS 302 or a computer system associated with EVCS 302 via wired or wireless connections such as via a Wi-Fi connection or Bluetooth connection.

In some embodiments, EVCS 302 further comprises one or more lights configured to provide predetermined illumination patterns indicating a status of EVCS 302. In some embodiments, at least one of the one or more lights is configured to illuminate an area proximal to EVCS 302 as a person approaches the area (e.g., a driver returning to a vehicle or a passenger exiting a vehicle that is parked in a parking spot associated with EVCS 302). In some embodiments, FIG. 3B illustrates the EVCSs displayed in FIGS. 1, 2A-E, and 3A. In some embodiments, FIG. 3B displays additional views of EVCS 302 shown in FIG. 3A. For example, EVCS 352 comprises housing 354, one or more displays 356, charging cable 358, charging cable holder 360, step-down transformer (not shown) and one or more cameras 362.

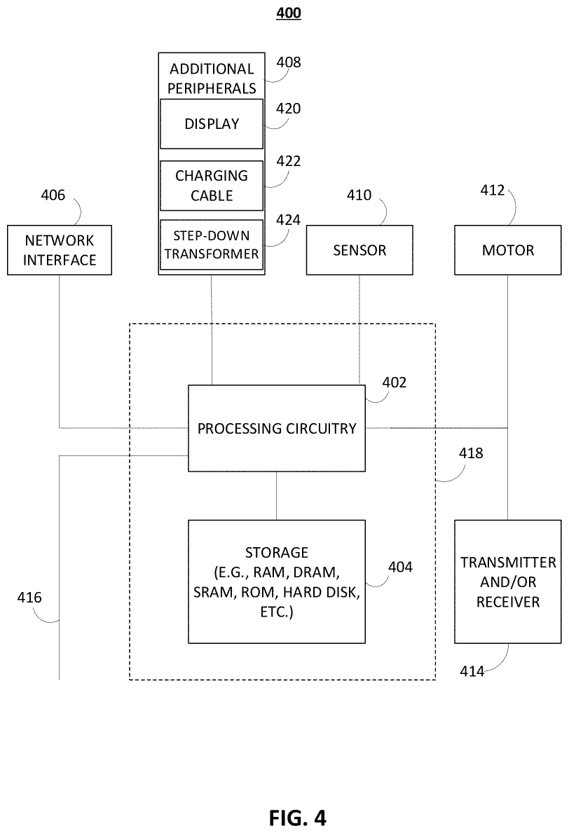

FIG. 4 shows an illustrative block diagram of an EVCS system 400, in accordance with some embodiments of the disclosure. In particular, EVCS system 400 of FIG. 4 may be any of the EVCSs depicted in FIGS. 1-3B. In practice, and as recognized by those of ordinary skill in the art, items shown separately could be combined and some items could be separated. In some embodiments, not all shown items must be included in EVCS 400. In some embodiments, EVCS 400 may comprise additional items.

The EVCS system 400 can include processing circuitry 402 that includes one or more processing units (processors or cores), storage 404, one or more network or other communications network interfaces 406, additional peripherals 408, one or more sensors 410, a motor 412 (configured to retract a portion of a charging cable), one or more wireless transmitters and/or receivers 414, and one or more input/output (“I/O”) paths 416. I/O paths 416 may use communication buses for interconnecting the described components. I/O paths 416 can include circuitry (sometimes called a chipset) that interconnects and controls communications between system components. EVCS 400 may receive content and data via I/O paths 416. The I/O path 416 may provide data to control circuitry 418, which includes processing circuitry 402 and a storage 404. The control circuitry 418 may be used to send and receive commands, requests, and other suitable data using the I/O path 416. The I/O path 416 may connect the control circuitry 418 (and specifically the processing circuitry 402) to one or more communications paths. I/O functions may be provided by one or more of these communications paths but are shown as a single path in FIG. 4 to avoid overcomplicating the drawing.

The control circuitry 418 may be based on any suitable processing circuitry such as the processing circuitry 402. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The charging functionality (e.g., determining the charging rate and stepping down the power, if necessary, for the determined charging rate) can be at least partially implemented using the control circuitry 418. The charging functionality described herein may be implemented in or supported by any suitable software, hardware, or combination thereof. The charging functionality can be implemented on user equipment, on remote servers, or across both.

The control circuitry 418 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 404 that is part of the control circuitry 418. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 404 includes one or more storage devices remotely located, such as a database of a server system that is in communication with EVCS 400. In some embodiments, the storage 404, or alternatively the non-volatile memory devices within the storage 404, includes a non-transitory computer-readable storage medium.

In some embodiments, storage 404 or the computer-readable storage medium of the storage 404 stores an operating system, which includes procedures for handling various basic system services and for performing hardware dependent tasks. In some embodiments, storage 404 or the computer-readable storage medium of the storage 404 stores a communications module, which is used for connecting EVCS 400 to other computers and devices via the one or more communication network interfaces 406 (wired or wireless), such as the Internet, other wide area networks, local area networks, metropolitan area networks, and so on. In some embodiments, storage 404 or the computer-readable storage medium of the storage 404 stores a media item module for selecting and/or displaying media items on the display(s) 420 to be viewed by passersby and users of EVCS 400. In some embodiments, storage 404 or the computer-readable storage medium of the storage 404 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 404 stores a subset of the modules and data structures identified above. In some embodiments, the storage 404 may store additional modules or data structures not described above.

In some embodiments, EVCS 400 comprises additional peripherals 408 such as displays 420 for displaying content, charging cable 422, and step-down transformer 424. In some embodiments, the displays 420 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed. In some embodiments, EVCS 400 receives power from a power source (e.g., central electrical room) at a higher voltage (e.g., 480 V) and the EVCS 302 can step down the power using the step-down transformer 424 (e.g., 15 kV transformer).

In some embodiments, EVCS 400 comprises one or more sensors 410 such as cameras (e.g., camera 116), ultrasound sensors, depth sensors, IR cameras, RGB cameras, PIR cameras, heat IR, proximity sensors, radar, tension sensors, NFC sensors, and/or any combination thereof.

In some embodiments, the one or more sensors 410 are for detecting whether external objects are within a region proximal to EVCS 400, such as living and nonliving objects, and/or the status of EVCS 400 (e.g., available, occupied, etc.) in order to perform an operation, such as determining a vehicle characteristic, user information, region status, allocation of service, etc.

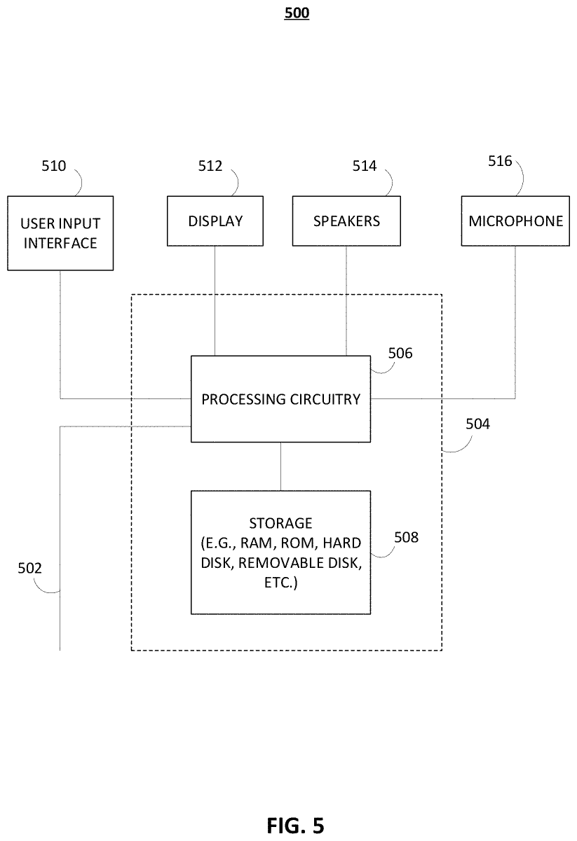

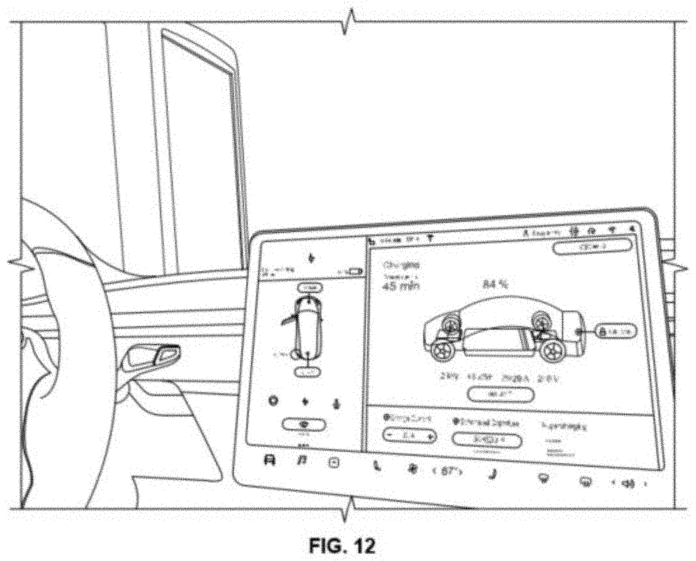

FIG. 5 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 500. In some embodiments, device 500 may comprise additional items. In an embodiment, the user equipment device 500 is the same user equipment device 108 of FIG. 1. In an embodiment, the user equipment device 500 is part of the electric vehicle (e.g., user equipment device shown in FIG. 12. The user equipment device 500 may receive content and data via I/O path 502. The I/O path 502 may provide audio content (e.g., broadcast programming, on-demand programming, Internet content, content available over a local area network (LAN) or wide area network (WAN), and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client/server-based embodiments, the control circuitry 504 may include communications circuitry suitable for communicating with one or more servers that may at least implement the described charging functionality. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 508 that is part of the control circuitry 504. Storage 508 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorder, or PVRs), solid-state devices, quantum storage devices, gaming consoles, gaming media, or any other suitable fixed or removable storage devices, and/or any combination of the same. The storage 508 may be used to store various types of content described herein. Nonvolatile memory may also be used (e.g., to launch a boot-up routine and other instructions). Cloud-based storage may be used to supplement the storage 508 or instead of the storage 508.

The control circuitry 504 may include audio-generating circuitry and tuning circuitry, such as one or more analog tuners, audio generation circuitry, filters or any other suitable tuning or audio circuits or combinations of such circuits. The control circuitry 504 may also include scaler circuitry for upconverting and down converting content into the preferred output format of the user equipment device 500. The control circuitry 504 may also include digital-to-analog converter circuitry and analog-to-digital converter circuitry for converting between digital and analog signals. The tuning and encoding circuitry may be used by the user equipment device 500 to receive and display, play, or record content. The circuitry described herein, including, for example, the tuning, audio-generating, encoding, decoding, encrypting, decrypting, scaler, and analog/digital circuitry, may be implemented using software running on one or more general purpose or specialized processors. If the storage 508 is provided as a separate device from the user equipment device 500, the tuning and encoding circuitry (including multiple tuners) may be associated with the storage 508.

The user may utter instructions to the control circuitry 504, which are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home and similar such voice assistants) receive and process the voice commands and other speech.

The user equipment device 500 may optionally include an interface 510. The interface 510 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the user equipment device 500. For example, the display 512 may be a touchscreen or touch-sensitive display. In such circumstances, the interface 510 may be integrated with or combined with the microphone 516. When the interface 510 is configured with a screen, such a screen may be one or more of a monitor, television, liquid crystal display (LCD) for a mobile device, active matrix display, cathode ray tube display, light-emitting diode display, organic light-emitting diode display, quantum dot display, or any other suitable equipment for displaying visual images. In some embodiments, the interface 510 may be HDTV-capable. In some embodiments, the display 512 may be a 3D display. The speaker (or speakers) 514 may be provided as integrated with other elements of user equipment device 500 or may be a stand-alone unit. In some embodiments, the display 512 may be outputted through speaker 514.

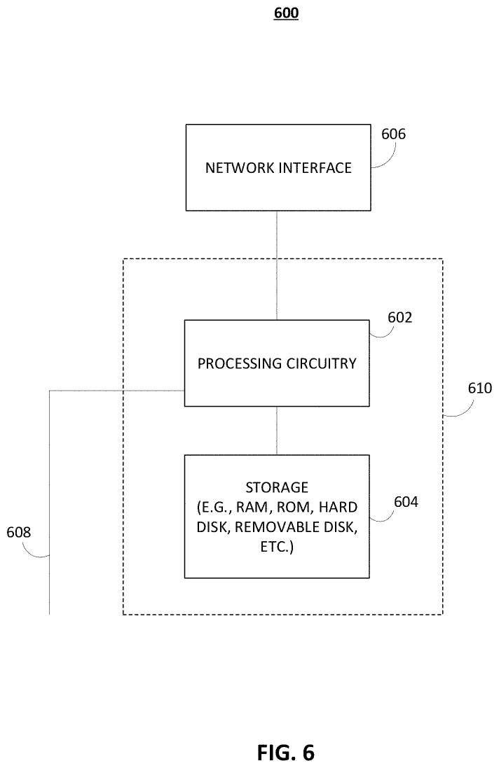

FIG. 6 shows an illustrative block diagram of a server system 600, in accordance with some embodiments of the disclosure. Server system 600 may include one or more computer systems (e.g., computing devices), such as a desktop computer, a laptop computer, and a tablet computer. In some embodiments, the server system 600 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 600. In some embodiments, server system 600 may comprise additional items.

The server system 600 can include processing circuitry 602 that includes one or more processing units (processors or cores), storage 604, one or more networks or other communications network interfaces 606, and one or more I/O paths 608. I/O paths 608 may use communication buses for interconnecting the described components. I/O paths 608 can include circuitry (sometimes called a chipset) that interconnects and controls communications between system components. Server system 600 may receive content and data via I/O paths 608. The I/O path 608 may provide data to control circuitry 610, which includes processing circuitry 602 and a storage 604. The control circuitry 610 may be used to send and receive commands, requests, and other suitable data using the I/O path 608. The I/O path 608 may connect the control circuitry 610 (and specifically the processing circuitry 602) to one or more communications paths. I/O functions may be provided by one or more of these communications paths but are shown as a single path in FIG. 6 to avoid overcomplicating the drawing.

The control circuitry 610 may be based on any suitable processing circuitry such as the processing circuitry 602. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 604 that is part of the control circuitry 610. Storage 604 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 604 or the computer-readable storage medium of the storage 604 stores an operating system, which includes procedures for handling various basic system services and for performing hardware-dependent tasks. In some embodiments, storage 604 or the computer-readable storage medium of the storage 604 stores a communications module, which is used for connecting the server system 600 to other computers and devices via the one or more communication network interfaces 606 (wired or wireless), such as the internet, other wide area networks, local area networks, metropolitan area networks, and so on. In some embodiments, storage 604 or the computer-readable storage medium of the storage 604 stores a web browser (or other application capable of displaying web pages), which enables a user to communicate over a network with remote computers or devices. In some embodiments, storage 604 or the computer-readable storage medium of the storage 604 stores a database for storing information on electric vehicle charging stations, their locations, media items displayed at respective electric vehicle charging stations, charging rate information, a number of each type of impression count associated with respective electric vehicle charging stations, and so forth.

In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 604 stores a subset of the modules and data structures identified above. In some embodiments, the storage 604 may store additional modules or data structures not described above.

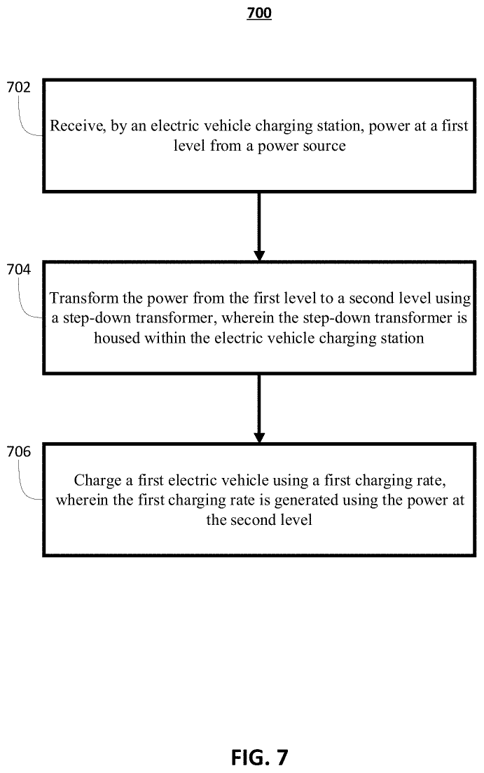

FIG. 7 is an illustrative flowchart of a process 700 for charging an electric vehicle using an EVCS comprising a step-down transformer, in accordance with some embodiments of the disclosure. Process 700 may be performed by physical or virtual control circuitry, such as control circuitry 418 of EVCS 400 (FIG. 4). In some embodiments, some steps of process 700 may be performed by one of several devices.

At step 702, control circuitry of an EVCS receives power at a first level from a power source. In some embodiments, the control circuitry of the EVCS receives the power at the first level from the power source in response to a charging event (e.g., an electric vehicle requesting charging from the EVCS). In some embodiments, the power source is a central electrical room. In some embodiments, the control circuitry receives power from the power source via cables. In some embodiments, the length of the cables can vary (e.g., 100 meters, 550 meters, etc.). In some embodiments, the first level corresponds to electricity at a first voltage. In some embodiments, the power at the first level is approximately 480 V. In some embodiments, the power source transmits power to the control circuitry of the EVCS at the first level because the EVCS comprises a step-down transformer. In some embodiments, when the power source transmits power at the first level to the control circuitry of the EVCS via cables there is less power loss compared to transmitting power at a lower level (e.g., 208 V) due to the higher voltage and lower current of the transmitted power.

At step 704, control circuitry of the EVCS transforms the power from the first level to a second level using a step-down transformer, wherein the step-down transformer is housed within the EVCS. In some embodiments, control circuitry of the EVCS transforms the power received from the power source from the first level (e.g., 480 V) to a second level, wherein the second level is lower than the first level. In some embodiments, the power at the second level is approximately 240 V. In some embodiments, control circuitry of the EVCS determines the second level before transforming the power from the first level to the second level. In some embodiments, control circuitry of the EVCS determines the second level based on a desired charging rate. In some embodiments, the second level is determined based on characteristics (e.g., model, make, specifications, condition, etc.) of the electric vehicle to be charged, user information (e.g., user's calendar, user feedback, user patterns, user profile, etc.), and/or location information (e.g., electrical grid information, site information, etc.). For example, control circuitry of the EVCS may determine an optimal power level and/or desired charging rate for charging the electric vehicle based on the make and model of the electric vehicle. The control circuitry of the EVCS can transform the power from the first level to the second level where the second level is the determined optimal power level based on characteristics of the electric vehicle.

In some embodiments, control circuitry of the EVCS may determine the second level based on the price paid by the user of the electric vehicle. For example, the user may select to charge their electric vehicle using a first charging rate, where the first charging rate is cheaper than a second charging rate. In some embodiments, control circuitry of the EVCS may determine a first charging rate power level and use the first charging rate power level as the second level. Accordingly, when a user selects a first charging rate, control circuitry of the EVCS will transform the power from a first level to a second level, wherein the second level corresponds to the first charging rate power level. In some embodiments, control circuitry of the EVCS determines that the power received from the power source does not need to be stepped down before charging the electric vehicle. For example, the user may select to charge their electric vehicle using the second charging rate, and the control circuitry of the EVCS may determine a second charging rate power level. The second charging rate power level may correspond to the level (e.g., first level) at which the power was received from the power source. Accordingly, when a user selects the second charging rate, control circuitry of the EVCS will not step down the power and will charge the electric vehicle using the power at the first level.

At step 706, control circuitry of the EVCS charges a first electric vehicle using a first charging rate, wherein the first charging rate is generated using the power at the second level. As discussed above, the second level and/or the first charging rate can be determined based on characteristics (e.g., model, make, specifications, condition, etc.) of the electric vehicle to be charged, user information (e.g., user's calendar, user feedback, user patterns, user profile, etc.), and/or location information (e.g., electrical grid information, site information, etc.). In some embodiments, control circuitry of the EVCS uses the determined first charging rate to determine the second level or vice versa. In some embodiments, the second level corresponds to 240 V and the first charging rate is 7 kW per hour. In some embodiments, the first level corresponds to 480 V and a second charging rate is 100 kW per hour.

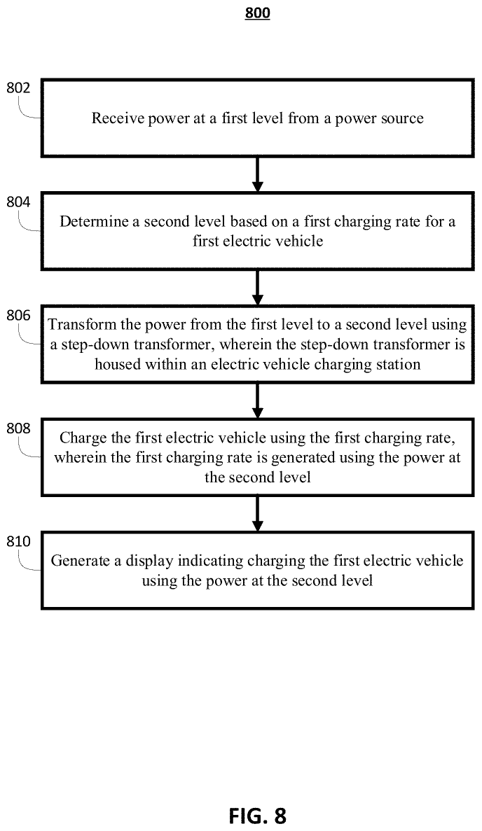

FIG. 8 is another illustrative flowchart of a process 800 for charging an electric vehicle using an EVCS comprising a step-down transformer, in accordance with some embodiments of the disclosure. Process 800 may be performed by physical or virtual control circuitry, such as control circuitry 418 of EVCS 400 (FIG. 4). In some embodiments, some steps of process 800 may be performed by one of several devices.

At step 802, control circuitry of an EVCS receives power at a first level from a power source. In some embodiments, the control circuitry of the EVCS receives the power at the first level from the power source in response to a charging event (e.g., an electric vehicle requesting charging from the EVCS). In some embodiments, the power source is a central electrical room. In some embodiments, the control circuitry receives power from the power source via cables. In some embodiments, the length of the cables can vary (e.g., 100 meters, 550 meters, etc.). In some embodiments, the first level corresponds to electricity at a first voltage. In some embodiments, the power at the first level is approximately 480 V. In some embodiments, the power source transmits power to the control circuitry of the EVCS at the first level because the EVCS comprises a step-down transformer. In some embodiments, when the power source transmits power at the first level to the control circuitry of the EVCS, via cables, there is less power loss compared to transmitting power at a lower level (e.g., 208 V) due to the higher voltage and lower current of the transmitted power.

At step 804, control circuitry of an EVCS determines a second level based on a first charging rate for a first electric vehicle. In some embodiments, the first charging rate corresponds to a desired charging rate. In some embodiments, the first charging rate is determined based on characteristics (e.g., model, make, specifications, condition, etc.) of the electric vehicle to be charged, user information (e.g., user's calendar, user feedback, user patterns, user profile, etc.), and/or location information (e.g., electrical grid information, site information, etc.). In some embodiments, control circuitry of the EVCS accesses a database that maps vehicle information to charging rates. For example, control circuitry of the EVCS may receive the make and model of the electric vehicle from a user device (e.g., user device 108 of FIG. 1) of the user. In some embodiments, control circuitry of the EVCS accesses a database with entries mapping the make and model of electric vehicles to charging rates.

In some embodiments, control circuitry of the EVCS may determine the first charging rate based on the price paid by the user of the electric vehicle. For example, the user may select to charge their electric vehicle using the first charging rate, where the first charging rate is cheaper than a second charging rate. In some embodiments, control circuitry of the EVCS may determine a first charging rate power level corresponding to the first charging rate. In some embodiments, the first charging rate power level is used as the second level.

At step 806, control circuitry of the EVCS transforms the power from the first level to a second level using a step-down transformer, wherein the step-down transformer is housed within the EVCS. In some embodiments, control circuitry of the EVCS transforms the power received from the power source from the first level (e.g., 480 V) to a second level, wherein the second level is lower than the first level. In some embodiments, the power at the second level is approximately 240 V. In some embodiments, control circuitry of the EVCS determines that the power received from the power source does not need to be stepped down before charging the electric vehicle. For example, the user may select to charge their electric vehicle using the second charging rate, and the control circuitry of the EVCS may determine a second charging rate power level. The second charging rate power level may correspond to the level (e.g., first level) at which the power was received from the power source. Accordingly, when a user selects the second charging rate, control circuitry of the EVCS will not step down the power and charge the electric vehicle using the power at the first level.

At step 808, control circuitry of the EVCS charges the first electric vehicle using a first charging rate, wherein the first charging rate is generated using the power at the second level.

At step 810, control circuitry of the EVCS generates a message indicating charging the first electric vehicle using the power at the second level. In some embodiments, the message is displayed on the display (e.g., display 118 of FIG. 1) of the EVCS. In some embodiments, the message is outputted from the EVCS to one or more other devices for display. For example, the message may be displayed on one or more user devices (e.g., device 108 of FIG. 1, user equipment device shown in FIG. 12., etc.). In some embodiments, the message indicates the charging rate (e.g., 7 kW per hour) and/or the and the second level (e.g., 240 V). In some embodiments, the message interface resembles the interface in FIG. 12.

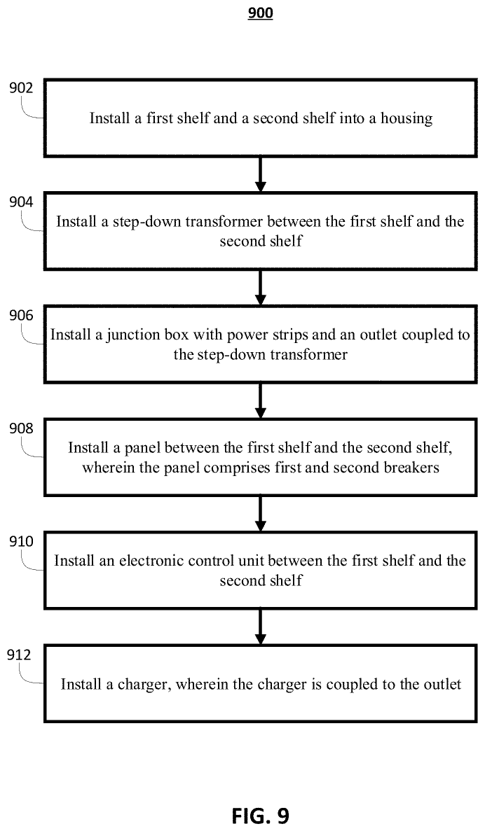

FIG. 9 is an illustrative flowchart of a process 900 for installing a step-down transformer into an EVCS, in accordance with some embodiments of the disclosure. In practice, and as recognized by those of ordinary skill in the art, the items described separately could be combined and some items could be separated. In some embodiments, not all described items must be included to install a step-down transformer into an EVCS.

At step 902, a first shelf and a second shelf are installed within the housing of an EVCS. In some embodiments, the first shelf is installed above the second shelf In some embodiments, the first and second shelves are installed in the bottom half of the housing of the EVCS. In some embodiments, the first and second shelf are installed after one or more components of the EVCS are removed.

At step 904, a step-down transformer is installed between the first shelf and the second shelf In some embodiments, the step-down transformer is a 15 kVA transformer. In some embodiments, similar such transformers may be used. In some embodiments, the step-down transformer is coupled to the first shelf and/or the second shelf

At step 906, a junction box with power strips and an outlet are installed. In some embodiments, the junction box and outlet are coupled to the top of the first shelf In some embodiments, the junction box comprises 120 V power strips. In some embodiments, the junction box and outlet are coupled to the transformer.

At step 908, a panel is installed between the first shelf and the second shelf In some embodiments, the panel comprises first and second breakers. In some embodiments, the first breaker is a 50 A breaker and the second breaker is a 20 A breaker. In some embodiments, similar such breakers may be used.

At step 910, an electronic control unit (ECU) is installed between the first and second shelves.

At step 912, a charger is installed. In some embodiments, the charger is coupled to the top of the first shelf In some embodiments, the charger is plugged into the outlet described above.

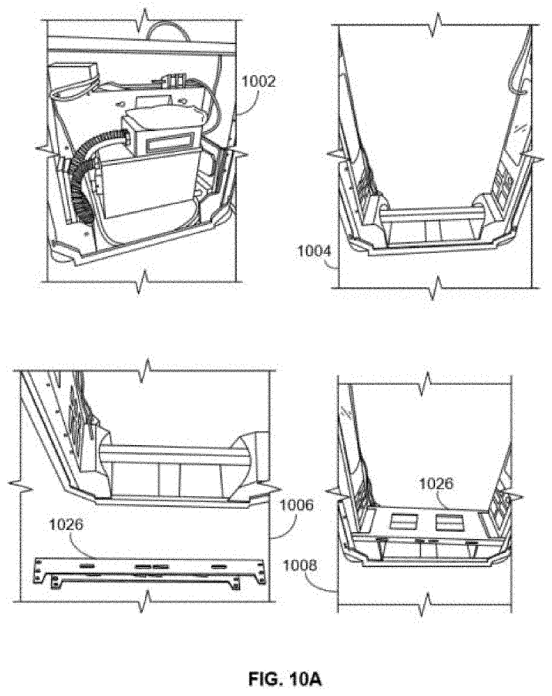

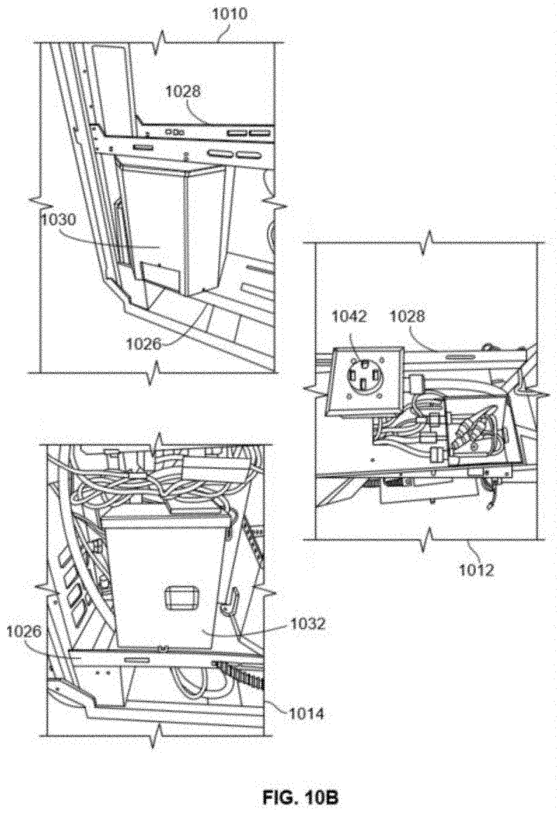

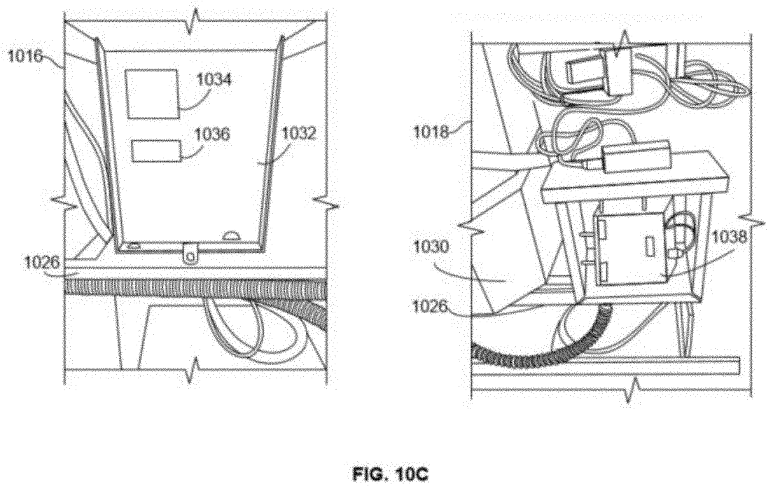

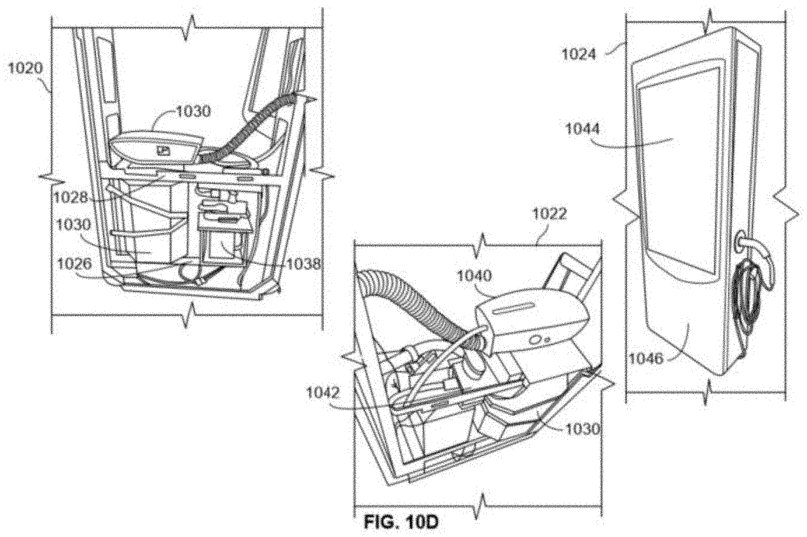

FIGS. 10A, 10B, 10C, and 10D illustrate an example of a process for installing a step-down transformer into an EVCS, in accordance with some embodiments of the disclosure. In some embodiments, FIGS. 10A, 10B, 10C, and 10D illustrate steps of the process 900 described in FIG. 9. In practice, and as recognized by those of ordinary skill in the art, the items described separately could be combined and some items could be separated. In some embodiments, not all described items must be included to install a step-down transformer into an EVCS.

In some embodiments, a process for installing a step-down transformer into an EVCS begins with the old EVCS system 1002 without a step-down transformer. As shown in step 1004, one or more of the components of the old EVCS system are removed.

As shown in step 1006 and 1008 a first shelf 1026 and a second shelf 1028 are installed within the housing of the EVCS. In some embodiments, the first shelf 1026 is installed above the second shelf 1028. In some embodiments, the first shelf 1026 and second shelf 1028 are installed in the bottom half of the housing of the EVCS.

As shown in step 1010, a step-down transformer 1030 is installed between the first shelf 1026 and the second shelf 1028. In some embodiments, the step-down transformer 1030 is a 15 kVA transformer. In some embodiments, similar such transformers may be used. In some embodiments, the step-down transformer 1030 is coupled to the first shelf 1026 and/or the second shelf 1028.

As shown in step 1012, a junction box with power strips and an outlet 1042 are installed. In some embodiments, the junction box and outlet are coupled to the top of the second shelf 1028. In some embodiments, the junction box comprises 120 V power strips. In some embodiments, the junction box and outlet are coupled to the transformer.

As shown in step 1014, a panel 1032 is installed above the first shelf 1026. As shown in step 1016, a first breaker 1034 and a second breaker 1036 is installed in the panel 1032. In some embodiments, the first breaker 1034 is a 50 A breaker and the second breaker 1036 is a 20 A breaker. In some embodiments, similar such breakers may be used.

As shown in step 1018, an electronic control unit (ECU) 1038 is installed above the first shelf 1026.

As shown in step 1020, a charger 1040 is installed on the top of the second shelf 1028.

As shown in step 1022, the charger 1040 is plugged into the outlet 1042. In some embodiments, a display 1044 and covering 1046 are installed onto the housing. As shown in step 1024, the EVCS comprising a step-down transformer is ready to be installed.

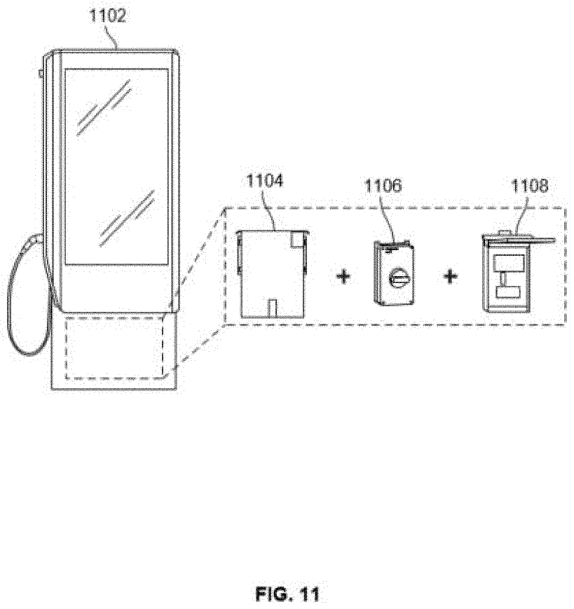

FIG. 11 illustrates an example of an EVCS 1102 comprising a step-down transformer, in accordance with some embodiments of the disclosure. In some embodiments, FIG. 11 illustrates the EVCSs displayed in FIGS. 1, 2A-E, and 3A-B. EVCS 1102 includes a housing (e.g., a body or a chassis) that holds a display and a step-down transformer 1104. In some embodiments, EVCS 1102 receives power from a power source (e.g., central electrical room) at a higher voltage (e.g., 480 V), and the EVCS 1102 can step down the power using the step-down transformer 1104. In some embodiments, EVCS 1102 is an older version of EVCS that has been converted to comprise the step-down transformer 1104, disconnect switch 1106, and a breaker panel 1108.

In some embodiments, to convert an older version of an EVCS to an EVCS 1102 comprising a step-down transformer requires a step-down transformer 1104 (e.g., 15 kVA single phase transformer), disconnect switch 1106, breaker panel 1108 (e.g., 125 A breaker panel), one or more breakers (e.g., 50 A breaker, 20 A breaker, etc.), one or more electrical outlet boxes, an outlet (e.g., 50 A outlet), plug (e.g., 50 A plug with 4′ cable), wire, one or more shelves, one or more power strips, one or more connectors (e.g., ½″ liquid tight connectors, ⅜″ connectors), energy control unit, one or more self-tapping screws, and/or metal strapping. In practice, and as recognized by those of ordinary skill in the art, the items described separately could be combined and some items could be separated. In some embodiments, not all described items must be included to convert an older version of an EVCS to an EVCS 1102 comprising a step-down transformer 1104. In some embodiments, EVCS 1102 may comprise additional items.

FIG. 12 illustrates an EVCS comprising a step-down transformer charging an electric vehicle, in accordance with some embodiments of the disclosure. As demonstrated by the system 1200, the EVCS is charging with 240 V and at a charging rate of 7 kW per hour. Stepping down the power at the EVCS results in a more efficient charging rate because the stepped-down power is transmitted directly to the electric vehicle after being stepped down instead of first being transmitting over cables from the power source. In some embodiments, the methodologies described herein result in the EVCS having excess power. For example, if an electric vehicle requires a first charging rate (e.g., 5 kW per hour), a first EVCS (without a step-down transformer) has to use all the stepped-down power received from the power source to charge the electric vehicle. However, a second EVCS with a step-down transformer may receive the power from the power source and step down the power to an appropriate level. The second EVCS may be able to charge the electric vehicle at a higher charging rate (e.g., 7 kW per hour) after stepping down the power because there it has less power loss than the first EVCS without the transformer. Instead of using the higher charging rate (e.g., 7 kW per hour), the second EVCS may charge the electric vehicle with the first charging rate (e.g., 5 kW per hour) and save any excess power for other functions. In some embodiments, the other functions may include powering the display (e.g., display 118 of FIG. 1), powering Wi-Fi offered by the EVCS, powering lights used to illuminate the space around the EVCS, and/or similar such functions.

It is contemplated that some suitable steps or suitable descriptions of FIGS. 7-10B may be used with other suitable embodiments of this disclosure. In addition, some suitable steps and descriptions described in relation to FIGS. 7-10B may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-6, and 11-12 could be used to perform one or more of the steps in FIGS. 7-10B.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving, by an electric vehicle charging station, power at a first level from a central power source;
transforming, by the electric vehicle charging station, the power from the first level to a second level using a step-down transformer, wherein the step-down transformer is housed within the electric vehicle charging station; and
charging, by the electric vehicle charging station, a first electric vehicle using a first charging rate, wherein the first charging rate is generated using the power at the second level.

2. The method of claim 1, further comprising charging, by the electric vehicle charging station, a second electric vehicle using a second charging rate, wherein the second charging rate is generated using the power at the first level.

3. The method of claim 1, wherein the electric vehicle charging station is a first distance from the central power source.

4. The method of claim 3, wherein the first distance is greater than 25 meters.

5. The method of claim 3, wherein the first distance is greater than 50 meters.

6. The method of claim 1, further comprising:
receiving, by the electric vehicle charging station, vehicle information relating to the first electric vehicle; and
determining, by the electric vehicle charging station, the first charging rate using the vehicle information.

7. The method of claim 6, wherein the vehicle information is inputted by a user.

8. The method of claim 6, wherein the vehicle information comprises the make of the first electric vehicle.

9. The method of claim 6, wherein the vehicle information comprises the model of the first electric vehicle.

10. The method of claim 6, wherein the vehicle information comprises charging parameters related to the first electric vehicle.

11. An apparatus comprising:
control circuitry;
a step-down transformer; and
at least one memory including computer program code for one or more programs, the at least one memory and the computer program code configured to, with the control circuitry, cause the apparatus to perform at least the following:
receive power at a first level from a central power source;
transform the power from the first level to a second level using the step-down transformer; and
charge a first electric vehicle using a first charging rate, wherein the first charging rate is generated using the power at the second level.

12. The apparatus of claim 11, wherein the apparatus is further caused to charge a second electric vehicle using a second charging rate, wherein the second charging rate is generated using the power at the first level.

13. The apparatus of claim 11, wherein the apparatus is a first distance from the central power source.

14. The apparatus of claim 13, wherein the first distance is greater than 25 meters.

15. The apparatus of claim 13, wherein the first distance is greater than 50 meters.

16. The apparatus of claim 11, wherein the apparatus is further caused to:
receive vehicle information relating to the first electric vehicle; and
determine the first charging rate using the vehicle information.

17. The apparatus of claim 16, wherein the vehicle information is inputted by a user.

18. The apparatus of claim 16, wherein the vehicle information comprises the make of the first electric vehicle.

19. The apparatus of claim 16, wherein the vehicle information comprises the model of the first electric vehicle.

20. The apparatus of claim 16, wherein the vehicle information comprises charging parameters related to the first electric vehicle.

21. An electric vehicle charging station comprising:
a terminal comprising a display and an interface, the interface receiving vehicle information, the vehicle information comprising charging parameters specific to an electric vehicle;
an input to receive power at a first level;
a step-down transformer, wherein the step-down transformer transforms the power received from the input from the first level to a second level;
a charging source connected to the step-down transformer, wherein the charging source uses the power at the second level to provide an electrical charge to the electric vehicle;
a connector for delivering the electrical charge from the charging source to the electric vehicle.
